(19) United States
(12) Patent Application Publication
(10) Pub. No.: US 2025/0078133 A1
(43) Pub. Date: Mar. 6, 2025

(54) SELECTING RECOMMENDATIONS BASED ON MACHINE LEARNING PREDICTION OF USER SENSITIVITY TO RELEVANCE OF RECOMMENDATIONS TO SEARCH RESULTS

(71) Applicant: Maplebear Inc., San Francisco, CA (US)

(72) Inventors: Brian Lin, La Canada Flintridge, CA (US); Angadh Singh, Dublin, CA (US); Sharath Rao Karikurve, Berkeley, CA (US)

(21) Appl. No.: 18/240,157

(22) Filed: Aug. 30, 2023

(51) Int. Cl. G06Q 30/0601; G06Q 30/0201

(52) U.S. Cl. CPC G06Q 30/0631; G06Q 30/0201; G06Q 30/0643

(57) ABSTRACT

Content items are presented to users based on sensitivity scores indicating sensitivity levels of users to relevance of content items to queries. A system receives a query from a target user, retrieves a set of search results responsive to the query, and retrieves a set of content items, each of which has a relevance score to the query. The system applies a machine learning model to user data of the target user to output a sensitivity score, indicating a sensitivity level of the target user to relevance of content item to the query. The system then selects one or more content items based on the sensitivity score and the relevance scores of the content items, incorporates the selected content items into the search results, and sends the search results with the selected content items for display to the target user.

### BACKGROUND

Existing online systems often allow users to enter queries to conduct searches. For example, when a user enters a query, including a particular search term, the online system conducts a search in its database and finds a list of search results. At the same time, the online system may also have the capability to suggest one or more sponsored content items. Generally, the online system identifies the sponsored content items that are the most relevant to the search term, integrates the most relevant sponsored content items into the search results, and presents the search results with the sponsored content items to users. For example, an online system may be an online concierge system that allows users to search for items that can be purchased from one or more retailers. The user may enter a query to search for a particular item. The online concierge system retrieves a list of search results and a list of sponsored content items that are related to the particular item, and presents both the search results and sponsored content items to the user. Such online systems not only help users to find what they are searching for but also help sponsors to showcase their products to users.

However, users are different individuals who have different sensitivity to the relevance of suggested content. For example, some users are open to exploration, while others are less tolerant of contextually irrelevant content. Users who are open to exploration do not mind less relevant content, but users who have a low tolerance for irrelevant content may get irritated by such content. Existing online systems do not know the sensitivities of users and cannot suggest different content to different users based on their sensitivities. As such, when a same search term is entered as a query by different users, the same sponsored content items are suggested to these different users.

### SUMMARY

Different users have different sensitivities to relevance of content. Some users are open to exploration, while others are less tolerant of contextually irrelevant content. Embodiments described herein solve this problem by applying one or more machine learning models to determine a sensitivity score of a user, and dynamically select one or more content items based on the sensitivity score of the user and relevance score of the content items.

Embodiments described herein include a system that receives a query from a target user and retrieves a set of search results responsive to the query. The system also retrieves a set of content items for inclusion within the search results. Each of the content items has a relevance score to the query. The system accesses a machine learning model trained to predict a sensitivity score that predicts a loss in engagement by a user with a set of search results caused by incorporating into the set of search results a content item that is selected without consideration of relevance to the search results. The system applies the machine learning model to user data of the target user to output a sensitivity score for the target user. The system selects one or more of the content items based on the sensitivity score and the relevance scores of the content items. A degree to which the relevance scores of the set of content items is used in the selecting is based on the sensitivity score. The system then incorporates the selected content items into the search results, and sends the search results with the selected content items for display to the target user. The sending causes a device of the target user to display the search results and the selected content items.

In some embodiments, the machine learning model includes a first model and a second model. The first model predicts whether a user will engage with a set of search results if a content item that is selected with consideration of relevance to the search results is incorporated into the set of search results, and the second model predicts whether a user will engage with a set of search results if a content item that is selected without consideration of relevance to the search results is incorporated into the set of search results.

In some embodiments, the machine learning model includes a conditional treatment effect model. A treatment is selecting a content item to be incorporated into the set of search results with consideration of relevance to the search results, and the machine learning model outputs a prediction of an increased likelihood in engagement with the search results if the treatment is selected.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example use interface showing a grid with search results and sponsored content items interspersed with each other in accordance with some embodiments.

FIG. 4A shows that average relevance scores in non-exploration mode are more concentrated on the higher side resulting in a left-skewed distribution in accordance with some embodiments.

FIG. 4B shows that the average top block relevance is more evenly distributed compared to the non-exploration mode in accordance with some embodiments.

FIG. 5 is a chart showing a distribution of numbers of less relevant sponsored content items in the top blocks for exploration mode in accordance with some embodiments.

FIG. 6 is a chart showing conversion rate/predicted click through rate (PCT) of total searches vs. number of less relevant sponsored content items in top six positions, in accordance with some embodiments.

FIG. 7 illustrates an example process of a user interacting with the online concierge system, in accordance with some embodiments.

FIG. 8 illustrates an example process of training the user sensitivity model.

FIG. 9 illustrates a flowchart of a method of selecting and presenting content items based on user sensitivity to relevance of content items to search terms, in accordance with some embodiments.

FIG. 10 illustrates a flowchart of a method of training machine-learning models in exploration mode and non-exploration mode, in accordance with some embodiments.

FIG. 11 illustrates a flowchart of a method of determining a sensitivity score of a target user, in accordance with some embodiments.

### DETAILED DESCRIPTION

Contextually relevant content can help users discover and shop from brands they love over time. Users are sensitive to the relevance of a content item on a surface and not the presence of the content itself. Some users are open to exploration, others are less tolerant of contextually irrelevant content to their current intent. However, no two users have the same regression in user action metrics (such as clicking a content item, or adding an item to a shopping cart, etc.) for the decrease in content relevance. Embodiments disclosed herein use machine learning to identify such a drop in user actions with respect to low relevance. While the regressions are expected across all content surfaces, “search” may be especially affected, followed by “buy it again’ and “browser” actions.

In some embodiments, sponsored content items are content items blended with organic search results. In some embodiments, organic search results and sponsored content items are presented as a grid with repetitive content load patterns, such as (but not limited to) x number of search results followed by y number of sponsored content, or vice versa. In some embodiments, a first few blocks in the presentation grid are sponsored, and the number of these blocks depends on factors like the content item inventory, relevance, bids, etc.

In some embodiments, the system described herein is an online concierge system that allows users to search for and order products from different retailers. Responsive to a search query from a user, the online concierge system identifies a set of organic search results. At the same time, the online concierge system also identifies a set of sponsored content items, each of which has a relevance score that predicts a loss in engagement by a user with a set of search results caused by incorporating into the set of search results a content item that is selected without consideration of relevance to the search results. The online concierge system applies a pre-trained machine learning model (also referred to as a user sensitivity model) to user data of the user to output a sensitivity score for the target user. The online concierge system then selects one or more sponsored content items from the set of sponsored content items based on both the sensitivity score of the user and the relevance score of the content items. A degree to which the relevance scores of the set of content items is used in the selecting is based on the sensitivity score. The selected sponsored content items are incorporated into the organic search results (e.g., arranged in a grid) and presented to the user.

In some embodiments, the machine learning model includes a first model and a second model. The first model predicts whether a user will engage with a set of search results if a content item that is selected with consideration of relevance to the search results is incorporated into the set of search results, and the second model predicts whether a user will engage with a set of search results if a content item that is selected without consideration of relevance to the search results is incorporated into the set of search results. The sensitivity score is a difference between an output of the first model and an output of the second model.

In some embodiments, training the first model is based on data describing user actions with a first set of search results when a first content item that is selected with consideration of relevance to the first set of search results is incorporated into the set of search results. Training the second model is based on data describing user actions with a second set of search results when a second content item that is selected without consideration of relevance to the second set of search results is incorporated into the second set of search results.

In some embodiments, the machine learning model includes a conditional treatment effect model. A treatment is selecting a content item to be incorporated into the set of search results with consideration of relevance to the search results. The machine learning model outputs a prediction of the increased likelihood in engagement with the search results if the treatment is selected.

In some embodiments, the online concierge system selects a first subset of search queries entered by users as in exploration mode, and selects a second subset of search queries entered by the users as in non-exploration mode. In some embodiments, for each search query in exploration mode, the online concierge system selects and incorporates a set of sponsored content items with a first minimum relevance score; on the other hand, for each search query in non-exploration mode, the online concierge system selects and incorporates a set of sponsored content items with a second minimum relevance score that is greater than the first minimum relevance score. In some embodiments, for each search query in exploration mode, the online concierge system selects and incorporates a set of sponsored content items into search results in random order. For each search query in non-exploration mode, the online concierge system selects and incorporates a set of sponsored content items based on their relevance to the corresponding query. For each of the users, the online concierge system computes a conditional average treatment effect (CATE) based on an average difference of user actions responsive to viewing the content items between exploration mode and non-exploration mode. The training of the machine learning model is based on the CATE.

In some embodiments, the online concierge system divides the users into multiple subsets based on their CATEs. For each subset of the users, the online concierge system determines an average CATE for the subset, and an actual treatment effect for the subset based on a difference between an average number of conversions in exploration mode and in non-exploration mode. The online system then determines a difference between the average CATE and the actual treatment effect in the subset. The training of the machine learning model is further based on the difference between the average CATE and the actual treatment effect in each subset.

In some embodiments, the system obtains additional training data that includes a label indicating whether the target user engaged with the search results sent to the target user and a set of features describing the target user. The system retrains the machine learning model using the additional training data.

In some embodiments, the system determines a minimum relevance threshold based on the sensitivity score, and determines whether a relevance score of a content item is greater than the minimum relevance threshold. Responsive to determining that the relevance score of the content item is greater than the minimum relevance threshold, the system selects the content item from the set of content items. In some embodiments, a greater sensitivity score corresponds to a higher minimum relevance threshold.

In some embodiments, the system stores the sensitivity score in connection with an account of the target user. In response to a subsequent search query from the target user, the system uses the stored sensitivity score to select one or more additional content items to include with a set of search results responsive to the subsequent query.

### Example Online Concierge System

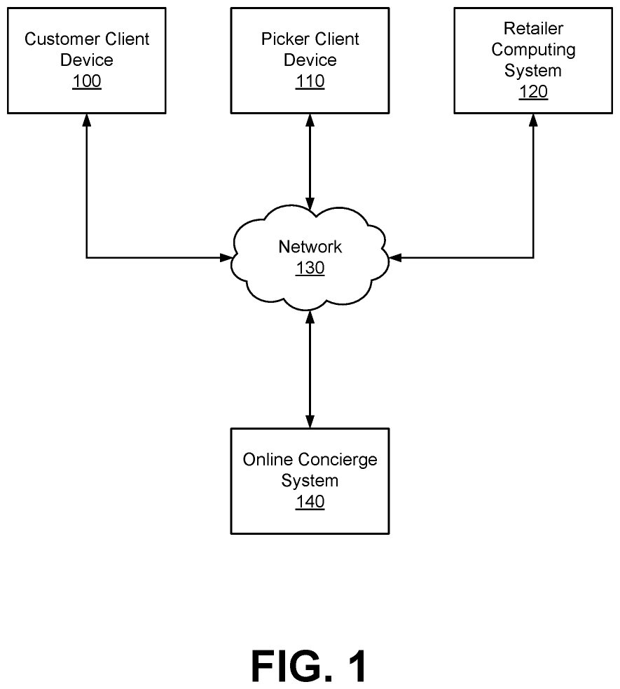

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile determining device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile determining device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a determining system operated by a retailer that interacts with the online concierge system 140. As used herein, a “retailer” is an entity that operates a “retailer location,” which is a store, warehouse, or other building from which a picker can collect items. The retailer computing system 120 stores and provides inventory data 246 to the online concierge system 140 and may regularly update the online concierge system 140 with updated inventory data 246. For example, the retailer computing system 120 provides inventory data 246 indicating which items are available at a retailer location and the quantities of those items. Additionally, the retailer computing system 120 may transmit updated inventory data 246 to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of determining devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one determining device to another determining device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between determining devices. In some embodiments, the network 130 may include Bluetooth or near-field communication (NFC) technologies or protocols for local communications between determining devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

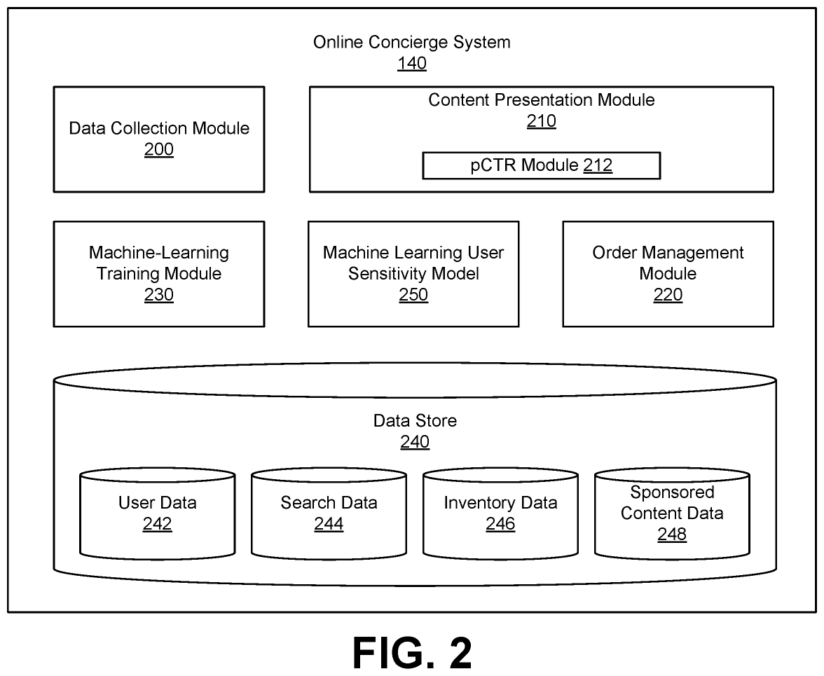

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, a machine learning user sensitivity model 250 (also referred to as user sensitivity model 250), and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data 242, which is information or data that describes characteristics of a user or customer. User data 242 may include a customer's name, address, shopping preferences, favorite items, or stored payment instruments. The user data 242 also may include default settings established by the customer, such as a default retailer/retailer location, payment instrument, delivery location, or delivery timeframe. The data collection module 200 may collect the user data 242 from sensors on the customer client device 100 or based on the customer's interactions with the online concierge system 140.

The data collection module 200 also collects inventory data 246, which is information or data that identifies and describes items that are available at a retailer location. The inventory data 246 may include item identifiers for items that are available and may include quantities of items associated with each item identifier. Additionally, inventory data 246 may also include attributes of items such as the size, color, weight, stock keeping unit (SKU), or serial number for the item. The inventory data 246 may further include purchasing rules associated with each item, if they exist. For example, age-restricted items such as alcohol and tobacco are flagged accordingly in the inventory data 246. Inventory data 246 may also include information that is useful for predicting the availability of items in retailer locations. For example, for each item-retailer combination (a particular item at a particular warehouse), the inventory data 246 may include a time that the item was last found, a time that the item was last not found (a picker looked for the item but could not find it), the rate at which the item is found, or the popularity of the item. The data collection module 200 may collect inventory data 246 from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include inventory data 246 for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as user data 242 for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on inventory data 246 for the items and user data 242 for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

In some embodiments, the content presentation module 210 is also configured to select sponsored content items based on the user sensitivity and relevance of the content items to the search query. A degree to which the relevance scores of the set of content items is used in the selecting is based on the sensitivity score. For example, when a user is more sensitive to relevance of sponsored content items, the content presentation module 210 prevents less relevant content items from being presented to the user. On the other hand, when a user is less sensitive to relevance of sponsored content items, the content presentation module 210 allows less relevant content items to be presented to the user. In some embodiments, the content presentation module 210 includes a predicted clickthrough rate (pCTR) module 212 configured to predict a click through rate of a content item, and the selection of the content item is in part based on the predicted click through rate.

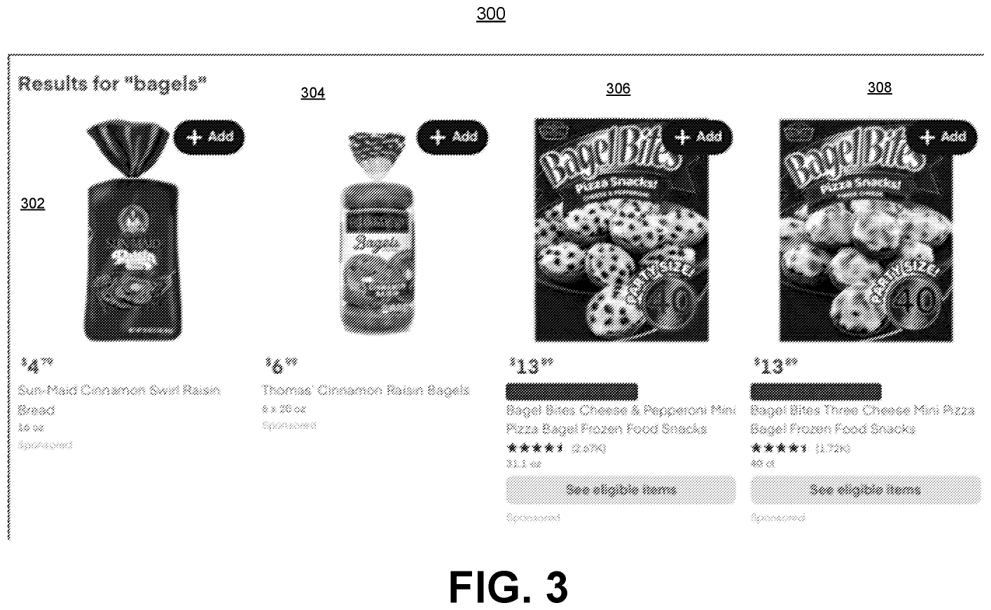

In some embodiments, the content presentation module 210 selects one or more content items based on a sensitivity score of a user and the relevance scores of the content items. The sensitivity score predicts a loss in engagement by a user with a set of search results caused by incorporating into the set of search results a content item that is selected without consideration of relevance to the search results. Additional details about embodiments of determining sensitivity scores of users are further described below with respect to FIGS. 3-11.

In some embodiments, the content presentation module 210 determines a minimum relevance threshold based on the sensitivity score, and determines whether a relevance score of a content item is greater than the minimum relevance threshold. Responsive to determining that the relevance score of the content item is greater than the minimum relevance threshold, the content presentation module 210 selects the content item from the set of content items. In some embodiments, a greater sensitivity score corresponds to a higher minimum relevance threshold. For example, a first user has a first sensitivity score, and a second user has a second sensitivity score that is greater than the first sensitivity score, indicating that the second user is more sensitive to relevance of content. As such, the content presentation module 210 selects content with a higher minimum relevance score for the second user.

In some embodiments, determining the minimum relevance threshold is further based on a value associated with the content item. In some embodiments, a value associated with the content item is a bid for a content item. For example, a bid for a content may be a cost to the content provider when the content item is displayed to a user, or when the content item is clicked by a user. In some embodiments, a value associated with the content item is a value of a product promoted by the content item. For example, a content item promoting a furniture set that costs about $1000 would be associated with a greater value than a content item promoting a grocery item that costs about $10. In some embodiments, a greater value associated with the content item corresponds to a higher minimum relevance threshold. For example, a content item promoting the furniture set may correspond to a higher minimum relevance threshold than a content item promoting the grocery item.

In some embodiments, the content presentation module 210 determines a minimum relevance score further based on data describing a query. For example, a query may be more specific or less specific. A more specific query may correspond to a higher minimum relevance score. For example, a query searching for “dinner” is less specific than a query searching for “steak.” Thus, content presentation module 210 may set a higher minimum relevance score for the query search for “steak” than the query search for “dinner.”

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models (e.g., machine-learning sensitivity model 250) to perform functionalities described herein. Example machine learning models include regression models, support vector machines, naïve bayes, decision trees, k nearest neighbors, random forest, boosting algorithms, k-means, hierarchical clustering, xgboost, meta learner, and double machine learning. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model (e.g., user sensitivity model 250) based on a set of training examples. Each training example includes input data to which the machine learning model is applied to generate an output. For example, each training example may include user data 242, picker data, inventory data 246, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The user sensitivity model 250 is trained to predict a user's sensitivity to relevance of sponsored content items to a search query. In some embodiments, the content presentation module 210 applies the user sensitivity model 250 to user data of a target user to determine a sensitivity score of the target user. In some embodiments, the user sensitivity model 250 is applied to the target user at a predetermined frequency, such as once a day, once a week, etc., based on updated user data. In some embodiments, the user sensitivity model 250 is applied to user data of each user at a predetermined frequency. In some embodiments, the user sensitivity model 250 is applied to user data of a user responsive to determining that the user data has changed, e.g., after the user enters a new query, or after the user enters a threshold number of new queries. In some embodiments, the user sensitivity model 250 is applied to user data of a user responsive to determining that a click through rate or conversion rate of the user is lower than a threshold.

The data store 240 stores data used by the online concierge system 140. For example, the data store 240 stores user data 242, search data 244, inventory data 246, and content data 248 for use by the online concierge system 140. In some embodiments, the data store further stores order data, and picker data. The user data 242 includes (but are not limited to) user profiles, personal information, historical orders made by users, etc. The inventory data 246 includes (but are not limited to) items that are available for users to order, volume of the items, historical orders including each item, etc. The content data 248 includes sponsored content items, and other information associated with the sponsored content items, such as minimum relevance score required for a sponsored content item to be presented to a user, a bid value of the sponsored content item, etc.

In some embodiments, the data store 240 may also store trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIG. 3 illustrates an example user interface 300 showing a grid with search results and sponsored content items interspersed with each other. A user has entered a search term “bagels” in a search query. Responsive to receiving the search term “bagels,” a list of organic search results are generated. At the same time, a content suggestion module is configured to identify a list of sponsored content items that are relevant to the search term “bagels.” The organic search results and the relevant content items are then arranged in a grid based on a content load pattern. For example, the first two blocks 302, 304 are used to present organic search results; the next two blocks 306, 308 are used to present sponsored content items; and so on and so forth.

### Training Machine Learning User Sensitivity Model

Since users are expected to examine sponsored content items before seeing the organic search results, presence of irrelevant content items could cause users to reformulate or navigate away from the search causing a poor search user experience. Search sponsored content items are retrieved using multiple major retrieval sources, such as (but not limited to) keyword bids, elastic search, and semantic search (e.g., artificial neural network). After a sequence of filtering and deduplicating stages, a pCTR module 212 predicts the expected clickthrough rate (CTR) for each of the remaining candidate sponsored content items. In some embodiments, the candidate sponsored content items are then input into a generalized second price auction and ranked in order of their eCPM (effective cost-per-mille or effective cost-per-thousand). The winner is displayed in the first sponsored block, the second in the second sponsored block, and so on and so forth.

While sponsored content items may be placed throughout the search grid periodically, it is proven that relevance of sponsored content in the top blocks is more relevant to user experience. In some embodiments, to identify the relationship between the relevance of the sponsored content items and user experience, the online concierge system 140 is configured to process queries in different modes, namely an exploration mode and a non-exploration mode. In some embodiments, only a small fraction (e.g., 0.5%) of queries are processed in exploration mode; and the rest of the queries are processed in non-exploration mode which is a regular mode. In some embodiments, in the exploration mode, the online concierge system 140 selects sponsored content items having a first minimum relevance score indicating relevance to the query or organic search results. On the other hand, in the non-exploration mode, the online concierge system 140 selects sponsored content items having a second minimum relevance score that is greater than the first minimum relevance score. In some embodiments, in the exploration mode, the online concierge system 140 is configured to randomly order sponsored content items for presentation. The rest of the search queries are in a non-exploration mode (which is the regular mode), in which the sponsored content items are presented in the order of their relevancies to search terms.

The exploration mode is designed to collect unbiased user feedback on sponsored content items for pCTR model training and offline evaluation. By randomizing the sponsored content items chosen and presented in the top sponsored block, a natural fortuitous experiment is created, where users are randomly exposed to a set of randomly ordered sponsored content items. In some embodiments, the presented sponsored content items are still expected to be “mostly” relevant, given that the sponsored content items selection is still optimized for contextual relevance.

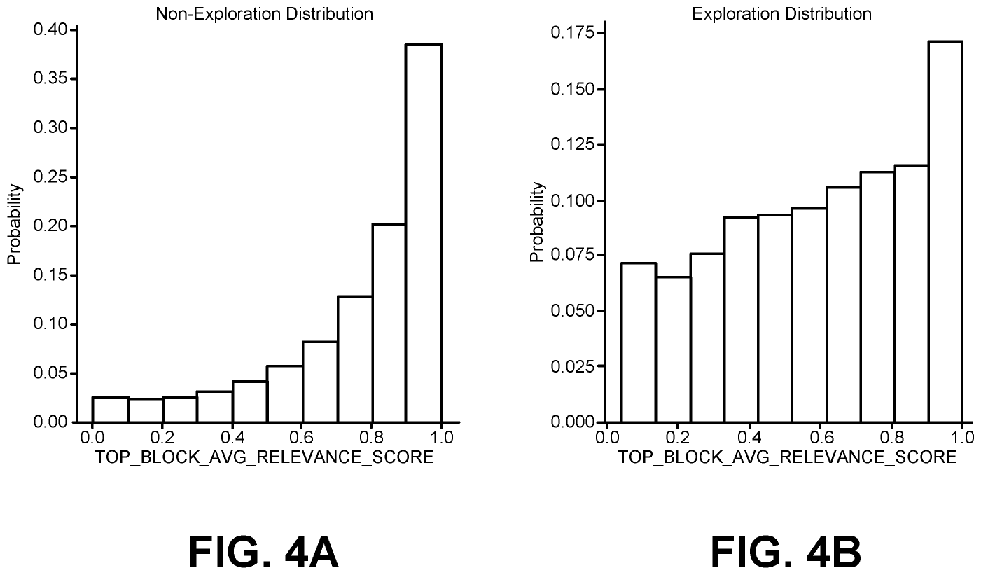

FIGS. 4A and 4B illustrate distributions of average top block relevance scores for non-exploration mode vs. exploration mode. FIG. 4A shows that average relevance scores in non-exploration mode are more concentrated on the higher side resulting in a left-skewed distribution. FIG. 4B shows that the average top block relevance is more evenly distributed compared to the non-exploration mode, although the optimization to fetch highly relevant sponsored content items in the exploration mode still results in a left skew but less so.

The existence of exploration mode enables the training of models to learn user sensitivity to relevance, as users are randomly exposed to top sponsored content blocks where relevance is lowered compared to in non-exploration mode with all other variables equal. Indeed, the exploration mode did result in a lower percentage of impressions with content clicks, indicating the existence of a relationship between relevance and user interest.

A search query includes one or more search terms that a user enters in a search engine to find things of interest. Responsive to receiving the search query, the search engine identifies a list of search results (also referred to as organic search results). A search auction is a process of selecting one or more sponsored items in response to a search query. In some embodiments, each search auction uses a threshold based on relevance scores associated with sponsored content items. A relevance score is a score derived from a (query, content item) pair. In some embodiments, the content items are associated with a product that the user is able to purchase, and the relevance score is a score derived from a (query, product) pair. In some embodiments, all content items that are below the relevance threshold are filtered out as they are considered not relevant to the search query, even in exploration mode. For example, in some embodiments, for a top block, the threshold is a first relevance score (e.g., 0.042); for a block at positions 2-3, the threshold is a second relevance score (e.g., 0.2); and for a block at positions 4-6, the threshold is a third relevance score (e.g., 0.55).

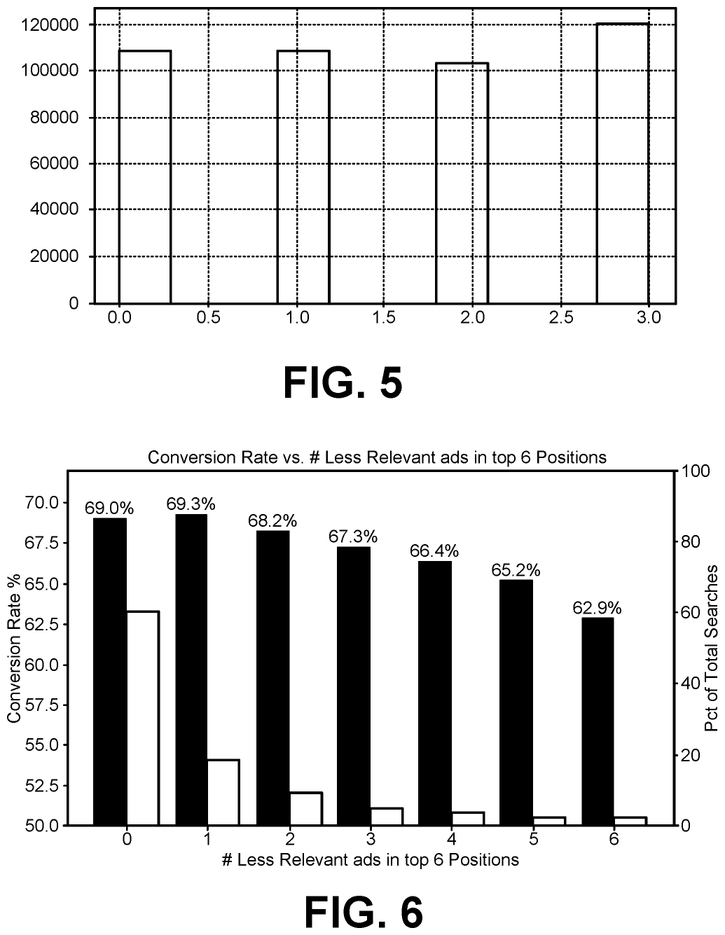

FIG. 5 is a chart showing a distribution of numbers of less relevant sponsored content items in top sponsored blocks for exploration mode. The x-axis represents a relevance score of sponsored content items. The y-axis represents a total number of sponsored content items are presented in top sponsored blocks. As illustrated, the first bar from the left represents that the least relevant sponsored content items (having a relevance score of 0.2) are presented to users in top sponsored blocks for about 110000 times.

FIG. 6 is a chart showing conversion rate/predicted click through rate (PCT) of total searches vs. number of less relevant sponsored content items in top six positions, where less relevant is defined as any content items with a relevance score less than 0.5. As illustrated, the overall conversion rate decreases with the number of less relevant sponsored content items in the top 6 positions. The predicted click through rate also decreases with the number of less relevant sponsored content items in the top 6 position.

The embodiments described herein include using machine learning to model user behavior at the search level. In some embodiments, the machine learning model is implemented at the online concierge system that allows users to search and order products from different retailers. The online concierge system trains a machine learning model based on user actions (e.g., click action or purchase action) responsive to sponsored content items, each of which has a relevance score indicating relevance of the sponsored content item to the search query. The machine learning model is trained to predict a user sensitivity for any given user that predicts a loss in engagement by the corresponding user with a set of search results caused by incorporating into the set of search results a content item that is selected without consideration (or at least with less consideration) of relevance to the search results. Responsive to receiving a search query from the user, the online concierge system selects a set of sponsored content items based on the user sensitivity, and the relevance score of the content items.

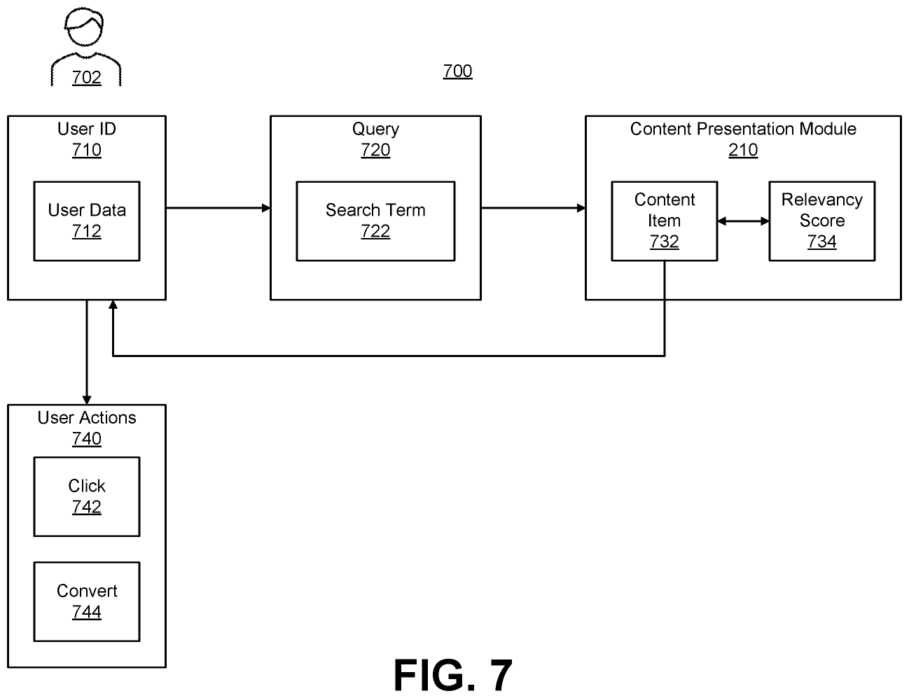

FIG. 7 illustrates an example process 700 of a user 702 interacting with the online concierge system 140. The user is associated with a user ID 710 having user data 712 stored in the data store 240. The user 702 enters a search query 720, including a search term 722 (e.g., “bagels”). The content presentation module 210 identifies a content item 732 associated with an item ID. The content item 732 also has a relevance score 734, indicating relevance of the candidate content item 732 to the search term 722. The content item 732 is then presented to the user 702. Responsive to viewing the content item 732, the user 702 may or may not perform one or more actions 740, such as a click action 742 (in which the user clicks the content item 732), a convert action 744 (in which the user purchases a product associated with the content item 732). The search query 720, the content item 732 and its relevance score 734, and the user actions 740 are recorded in the data store 240. The recorded data can then be used to train the user sensitivity model 250.

In some embodiments described above, a fraction of search queries (e.g., 0.5%) are processed in an exploration mode, in which the content presentation module 210 randomly orders sponsored content items in a presentation grid. The rest of the search queries are processed in a non-exploration mode, in which the content suggestion module 200 presents sponsored content items in a presentation grid based on their relevance to the search term. The data associated with the search queries, the relevance score of the sponsored content items presented to the users, and user actions are recorded in the data store 240.

In some embodiments, for each search results page rendered, an outcome (denoted as Y) includes a number of conversions for that search result by the user. Treatment includes whether the user is in exploration mode (denoted as T). Multiple control variables (denoted as W) are used. The control variables may include user search features, such as (but not limited to) a number of times the user searched for this term in the past, past user conversions for the search term. Control variables may also include user's general search behavior features, such as (but not limited to) the user's average search conversion depth, average specificity of user searches in the past, etc. The control variables may also include context features, such as (but not limited to) average number of sponsored content items in top blocks, a number of sponsored content items overall, a number of organic products overall, average organic products sponsored content relevance score for display position <=10, a device type, etc. The control variables may also include historical search features, such as (but not limited to) historical CTR of the search term (e.g., in past 28 days, months, etc. before the first date of data in training data), search term popularity, a number of users who searched this term, search term specificity, etc.

The model also uses user features (denoted as “X”). For example, the model may use user features including (but not limited to) a number of searches in past 28 days, a number of unique searches in past 28 days, a number of conversions in past 28 days, gross merchandise value (GMV) in past 28 days, a number of products in past 28 days, a number of deliveries in past 28 days, an average number of relevant ads in top block in past 28 days, etc.

In some embodiments, the machine-learning training module 230 models a conversion rate Y as a function of X, T, and W, represented by Equation (1) below:

$$Y = f ( T , ( X , W ) ) = Y ( X , T , W ) . \qquad Equation ( 1 )$$

The goal of the modeling is to understand how an increase in a number of less relevant content items affects a user's conversions (Y) averaged over covariates/control variables (W) over a user's search history (X). In some embodiments, the model is able to estimate the conditional average treatment effect (CATE) at a user level (as opposed to search level), represented by Equation (2) below.

$$Equation ( 2 )$$

$$CATE ( {x}_{i} ) = E [ Y ( T = {T}_{2} ) - Y ( T = {T}_{1} ) \vert X - {x}_{i} ] for all users {x}_{i} in X .$$

In some embodiments, the user sensitivity model 250 is trained using meta-learner. In embodiments, the model is not just used in estimating a causal effect, but also in whether this effect is different for different users. This knowledge is advantageous because it allows the system to target the treatment. If a user is very sensitive to relevance of suggested content, the system will limit irrelevant content from being presented to the user. Here, to understand the effect of relevance of suggested content, the system runs an AB test in which users are randomly presented with less relevant content items at a predetermined percentage (e.g., 0.5%) of search queries.

The model is trained using treatment (T), user features (X), and/or contextual features to predict a conversion rate Y. In some embodiments, the model is trained using a gradient boosting framework, such as xgboost. In some embodiments, for each user (denoted xi), all historical searches (wij in W) are iterated to compute conversion rate Y, represented by Equations (3)-(4) below:

$$Y ( X = {x}_{i} , T = {T}_{2} , W - {w}_{ij} ) \qquad Equation ( 3 )$$

$$Y ( X = {x}_{i} , T = {T}_{1} , W - {w}_{ij} ) . \qquad Equation ( 4 )$$

In some embodiments, a difference for each user is computed. An average of all the differences is computed to obtain a sensitivity score, represented by Equation (5) below:

$$CATE ( {x}_{i} ) = \frac{1}{{N}_{i}} {\sum }_{{w}_{ij} ∈ {w}_{i}} \qquad Equation ( 5 )$$

$$Y ( X = {x}_{i} , T = {T}_{2} , W = {W}_{ij} ) - Y ( X = {x}_{i} , T = {T}_{1} , {w}_{ij} )$$

In some embodiments, a double machine learning (DML) estimator is implemented to estimate the heterogeneous treatment effects, where whether the user is in exploration mode is the treatment. The model is trained to measure the causal effect of the treatment variable T on the outcome variable Y, controlling for the set of features X and W, and how that effect may vary as a function of X. Once the model is trained, it can be used to estimate a value of an outcome variable Y for any given set of features X and W and a value of the treatment variable T.

To evaluate the performance of the calculated CATEs (conditional average treatment effect), the following evaluation schemes may be conducted, similar to the customer elasticity estimates. A week of held-out non-exploration data is obtained. For this held-out set, the user level CATE estimates are computed based on the methodology for the day of the observation.

In some embodiments, the users are divided into deciles based on the estimated CATEs. For each decile, the average estimated CATE is computed for each decile and compared with the actual treatment effect in the decile. The actual treatment effect is the difference between the average number of conversions in exploration mode and in non-exploration mode. The estimated CATEs are compared with the observed CATEs for each decile. The estimates are good if the observed CATEs are monotonically increasing and reasonably calibrated to the observed CATEs.

In some embodiments, the machine learning model includes a first model and a second model. The first model is trained based on data describing user actions with a first set of search results when a first content item that is selected with consideration of relevance to the first set of search results is incorporated into the first set of search results. The second model is trained based on data describing user actions with a second set of search results when a second content that is selected without consideration (or at least with less consideration) of relevance to the second set of search results is incorporated into the second set of search results. The second model is trained to predict a second likelihood of a conversion following presentation of the second set of search results and the second content item for the target user. In some embodiments, the first model is trained based on data describing user actions in the non-exploration mode; and the second model is trained based on data describing user actions in the exploration mode.

The two models can form a model to predict a loss of engagement, e.g., by connecting them such that the output of the first machine-learning model and the output of the second machine-learning model are compared to determine a difference, indicating a loss of engagement with search results.

In some embodiments, the online concierge system stores the sensitivity score in connection with an account of the target user. In response to a subsequent search query from the target user, the online concierge system uses the stored sensitivity score to select one or more additional content items to include with a set of search results responsive to the subsequent query.

In some embodiments, the sensitivity score for each user is updated at a predetermined frequency. For example, a daily update may be performed to update a sensitivity score for each user. User features are obtained and stored in a data system. An upstream dependency job may also be performed to compute user features and search features on a daily basis. In some embodiments, the tables with the past D days of search impressions are joined to calculate Y 0 for each impression. The search impressions are then grouped by user to get an average difference to compute the user's sensitivity.

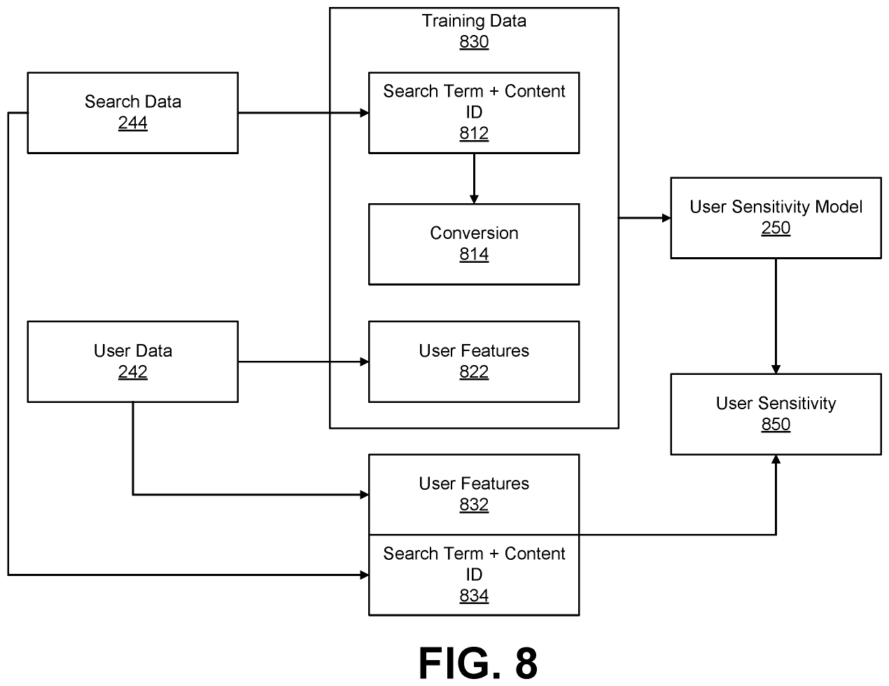

FIG. 8 illustrates an example process of training the user sensitivity model 250. Training data 830 are obtained from search data 244 and user data 242. As illustrated, the training data 830 include (search term, content ID) pairs 812, conversions 814, and user features 822. A content ID is an identifier of a sponsored content item that is presented to the user responsive to a search query, including the search term. A conversion 814 is whether a sponsored content item is converted into a purchase transaction, or a click. Each conversion 814 is also associated with a content ID that is associated with a corresponding sponsored content item. The user features 822 are extracted from user data 242.

The training data 830 are used to train the user sensitivity model 250 that models relationship between user features and user sensitivities. In such embodiments, a user's sensitivity does not change when different queries are entered by the user. For each given user associated with a set of user features 832, the user sensitivity model 250 is configured to predict the user's sensitivity 850 to relevance of sponsored content.

In some embodiments, the training data 830 are used to train the user sensitivity model 250 that models relationship among user features, search queries, content items, and user sensitivities. In such embodiments, a user's sensitivity changes when different queries are entered by the user. For each given query, the user sensitivity model 250 is configured to predict the user's sensitivity 850 based not only on user features 832 but also on search term, and content item ID 834.

In some embodiments, the online concierge system obtains additional training data that comprises a label indicating whether a target user engaged with the search results sent to the target user and a set of features describing the target user. The machine learning model may be retrained using the additional training data.

### Example Method of Selecting and Presenting Content Items Based on User Sensitivity

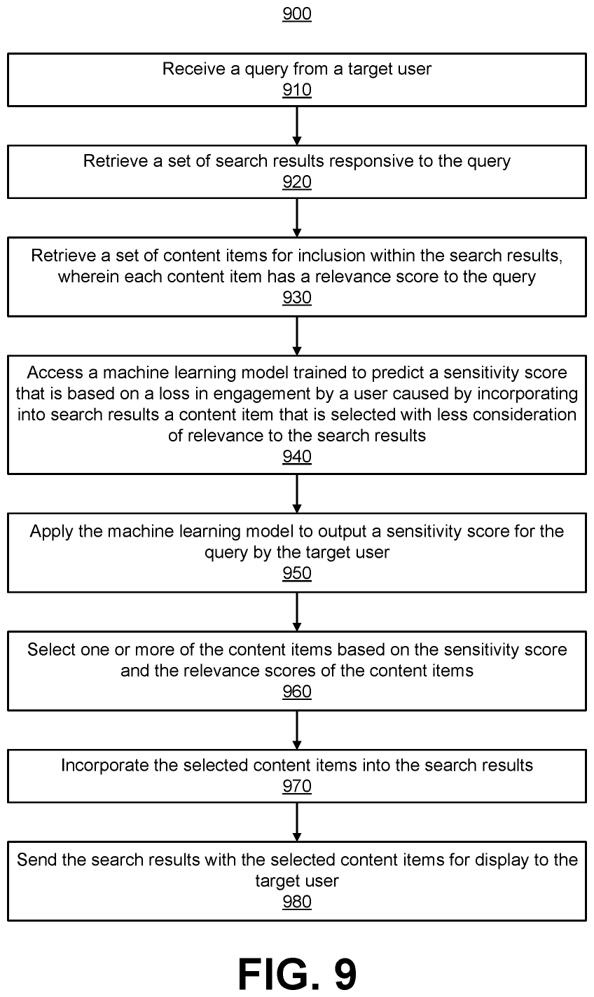

FIG. 9 illustrates a flowchart 900 of a method of selecting and presenting content items based on user sensitivity to relevance of content items to search terms. Alternative embodiments may include more, fewer, or different steps from those illustrated in FIG. 9, and the steps may be performed in a different order from that illustrated in FIG. 9. These steps may be performed by an online concierge system (e.g., online concierge system 140). Additionally, each of these steps may be performed automatically by the online concierge system without human intervention.

The online concierge system 140 receives 910 a query from a target user. The query includes one or more search terms. The target user may be using their mobile app or web browser to enter the query.

The online concierge system 140 retrieves 920 a set of search results responsive to the query. In some embodiments, responsive to receiving the query, the online concierge system 140 conducts a search in its inventory database to identify a set of search results. In some embodiments, the online concierge system 140 determines a relevance score for each search result, sorts the search results based on their relevance, and identifies a top few search results to be returned to the target user.

The online concierge system 140 also retrieves 930 a set of content items for inclusion within the search results. Each content item has a relevance score to the query. In some embodiments, the content items are sponsored content items. In some embodiments, the query includes a search term associated with an item that a user wishes to purchase. The sponsored content items are associated with the item that the user wishes to purchase.

The online concierge system 140 accesses 940 a machine learning model (e.g., the sensitivity model 250 trained on user data 242 and search data 244) to predict a sensitivity score that predicts a loss in engagement by a user with a set of search results caused by incorporating into the set of search results a content item that is selected without consideration of relevance to the search results.

The online concierge system 140 applies 950 the machine learning model to user data of the target user to output a sensitivity score for the query by the target user, and selects 960 one or more of the content items based on the sensitivity score and the relevance scores of the content items. A degree to which the relevance scores of the set of content items is used in the selecting is based on the sensitivity score. Generally, a higher sensitivity score of the target user results in selecting content items having greater relevance scores. In some embodiments, the online concierge system determines a minimum relevance threshold based on the sensitivity score, and determines whether a relevance score of a content item is greater than the minimum relevance threshold. Responsive to determining that the relevance score of the content item is greater than the minimum relevance threshold, the online concierge system 140 selects the content item from the set of content items.

In some embodiments, the sensitivity score is stored in connection with an account of the target user. In response to a subsequent search query from the target user, the online concierge system 140 uses the stored sensitivity score to select one or more additional content items to include with a set of search results responsive to the subsequent query.

In some embodiments, the machine learning model is applied to the target user at a frequency (e.g., once per day) to update the sensitivity score of the target user based on updated user data of the target user. In some embodiments, the machine learning model is applied to each user at a frequency (e.g., once per day) to update the sensitivity score of the corresponding user based on updated user data of the corresponding user. Alternatively, or in addition, in some embodiments, the machine learning model is applied to a user responsive to determine that the user has entered a threshold number of new queries. Alternatively, or in addition, in some embodiments, the machine learning model is applied to a user responsive to determining that the conversion rate of the user has dropped to a threshold level.

The online concierge system 140 incorporates 970 the selected content items into the search results and sends 980 the search results with the selected content items for display to the target user. In some embodiments, the search results and the content items are arranged in a grid of blocks based on a pattern, e.g., x number of search results followed by y_number of content items. In some embodiments, the machine learning model is trained based on user actions associated with content items that are placed in a top number of blocks in the grid.

In some embodiments, the machine learning model includes a first model and a second model. The first model predicts whether a user will engage with a set of search results if a content item that is selected with consideration of relevance to the search results is incorporated into the set of search results. The second model predicts whether a user will engage with a set of search results if a content item that is selected without consideration of relevance to the search results is incorporated into the set of search results. The sensitivity score is a difference between an output of the first model and an output of the second model.

In some embodiments, the first model is trained based on data describing user actions with a first set of search results when a first content item that is selected with consideration of relevance to the first set of search results is incorporated into the first set of search results. The second model is trained based on data describing user actions with a second set of search results when a second content item that is selected without consideration of relevance to the second set of search results is incorporated into the second set of search results.

In some embodiments, the online concierge system selects a first subset of search queries (e.g., 0.5%) entered by users as in exploration mode, and selects a second subset of search queries as in non-exploration mode. For each search query in the exploration mode, the online concierge system retrieves a set of search results responsive to the query; selects a set of content items for inclusion within the search results, each of which has a relevance score to the query; and incorporates the selected content items into the search results in a random order. For each search query in the non-exploration mode, the online concierge system incorporates selected content items into the search results in an order based on their respective relevance scores, such that the content item having a highest relevance score is placed at a top position. The machine learning model is trained based on user data and search data associated with the users and the queries in the exploration mode and non-exploration mode.

In some embodiments, for a query in exploration mode, a first number of top blocks are allocated to randomly place content items having relevance scores greater than a first threshold, and a second number of top blocks that are subsequent to the first number of top blocks are allocated to randomly place content items having relevance scores greater than a second threshold, where the second threshold is greater than the first threshold.

Whether users were in exploration mode or non-exploration mode when the search queries were entered are used as a treatment for training the machine learning model. For each user, a conditional average treatment effect (CATE) is computed based on an average difference of user actions responsive to viewing the content items between exploration mode and non-exploration mode. In some embodiments, the users are divided into a plurality of subsets (e.g., deciles). For each subset of users, the online concierge system computes an average CATE and an actual treatment effect in the subset. The actual treatment effect is a difference between an average number of conversions in exploration mode and in non-exploration mode. The online concierge system 140 then determines a difference between the average CATE and an actual treatment effect in the subset. The machine learning model is further trained based on the difference between the average CATE and the actual treatment effect in each subset. In some embodiments, the machine learning model is trained via a meta learner method. In some embodiments, the machine learning model is trained via a double machine learning method.

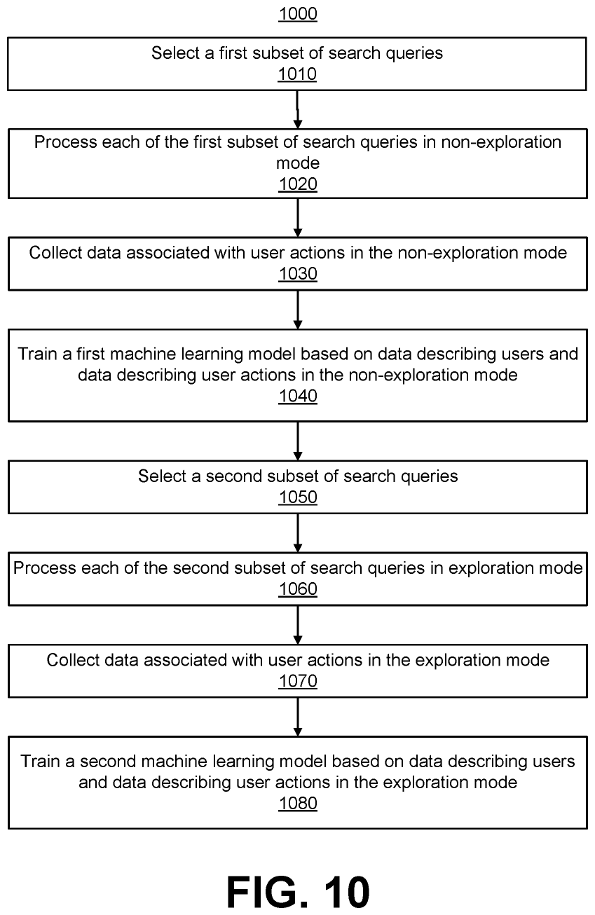

FIG. 10 illustrates a flowchart of a method 1000 of training machine-learning models in non-exploration mode and exploration mode, in accordance with some embodiments. Alternative embodiments may include more, fewer, or different steps from those illustrated in FIG. 10, and the steps may be performed in a different order from that illustrated in FIG. 10. These steps may be performed by an online concierge system (e.g., online concierge system 140) or by a training system.

The online concierge system 140 selects 1010 a first subset of search queries, and processes 1020 each of the first subset of search queries in non-exploration mode. For each search query in the non-exploration mode, the online concierge system 140 retrieves a first set of search results responsive to the query, and selects a first set of content items for inclusion with the search results, where each of the first set of content items has a first minimum relevance score to the first set of search results. The online concierge system 140 incorporates the selected first set of content items into the search results. The online concierge system 140 then collects 1030 data describing user actions in the non-exploration mode, and trains 1040 a first machine learning model based on data describing user actions in the non-exploration mode. The first machine learning model is trained to determine a first likelihood of a conversion following presentation of the selected first set of search results for a given user in the non-exploration mode.

The online concierge system 140 also selects 1050 a second subset of search queries, and processes 1060 each of the second subset of search queries in exploration mode. For each search query in the exploration mode, the online concierge system 140 retrieves a second set of search results responsive to the query, and selects a second set of content items for inclusion within the second set of search results, where each of the second set of content items has a second minimum relevance score to the query that is lower than the first minimum relevance score. In some embodiments, the second set of content items are selected without consideration of relevance score at all (e.g., the second minimum relevance score may be 0, indicating not relevant at all). For example, in some embodiments, the second set of content items may be randomly selected. The online concierge system 140 incorporates the selected second set of content items into the second set of search results.

The online concierge system 140 then collects 1070 data describing user actions in the exploration mode, and trains 1080 a second machine learning model based on data describing user actions in the exploration mode. The second machine learning model is trained to determine a second likelihood of a conversion following presentation of the second set of search results for a given user in the exploration mode.

In some embodiments, the first subset of search queries processed in exploration mode is a small fraction of the search queries, e.g., 0.5%. The rest of the search queries are processed in non-exploration mode (which is the normal mode).

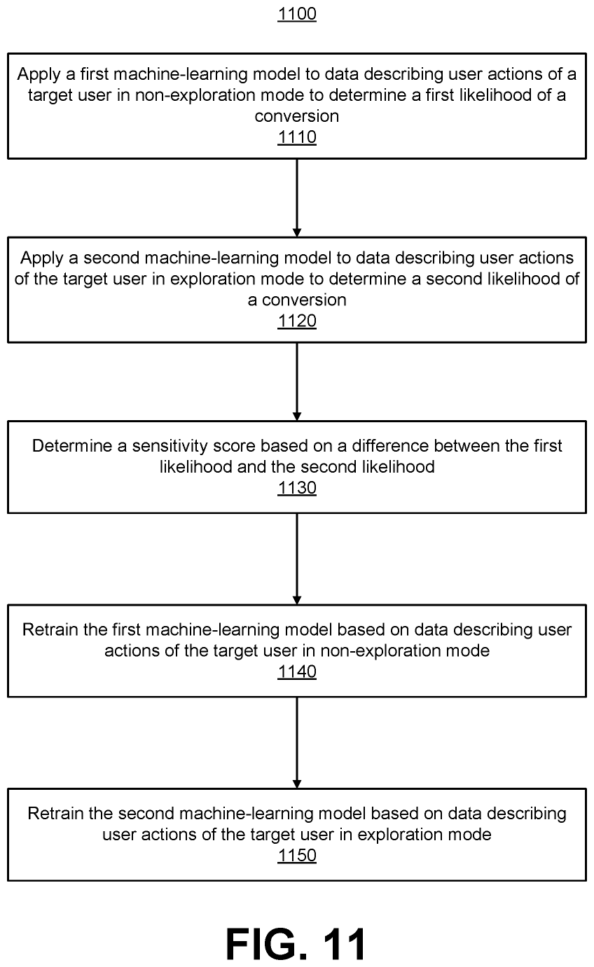

FIG. 11 illustrates a flowchart of a method 1100 of determining a sensitivity score of a target user, in accordance with some embodiments. Alternative embodiments may include more, fewer, or different steps from those illustrated in FIG. 11, and the steps may be performed in a different order from that illustrated in FIG. 11. These steps may be performed by an online concierge system (e.g., online concierge system 140).

The online concierge system 140 applies 1110 a first machine-learning model to data describing user actions of a target user in non-exploration mode to determine a first likelihood of a conversion following presentation of search results for the target user in the non-exploration mode. The online concierge system 140 applies 1120 a second machine-learning model to data describing user actions of the target user in exploration mode to determine a second likelihood of a conversion. The online concierge system 140 determines 1130 a sensitivity score based on a difference between the first likelihood and the second likelihood.

In some embodiments, a sensitivity score of each of a set of users is determined and stored in connection with an account of each corresponding user. In response to a subsequent search query from a target user, the online concierge system 140 uses the stored sensitivity score to select one or more content items to include with a set of search results responsive to the subsequent query. In some embodiments, the sensitivity score of each of the set of users is determined at a frequency, e.g., once per day, once per week, once per month, etc.

In some embodiments, additional training data is obtained based on user actions of the set of users in exploration mode and non-exploration mode. In some embodiments, the online concierge system 140 retrains 1140 the first machine learning model based on data describing user actions of the target user (or the set of users) in exploration mode. Similarly, the online concierge system 140 may also retrain 1150 the second machine learning model based on data describing user actions of the target user (or the set of users) in non-exploration mode. In some embodiments, retraining the first or second machine learning models may be performed periodically. In some embodiments, retraining the first or second machine learning model may be triggered based on a threshold amount of new data describing users (e.g., a number of new users added to the system) and/or new data describing user actions (e.g., a number of search queries performed).

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a determining process described herein. Such a product may store information resulting from a determining process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, at a computer system comprising a processor and a computer-readable medium, comprising:
receiving a query from a target user;
retrieving a set of search results responsive to the query;
retrieving a set of content items for inclusion within the set of search results, where each of the set of content items has a relevance score to the query;
accessing a machine learning model trained to predict a sensitivity score that predicts a loss in engagement by a user with a set of search results caused by incorporating into the set of search results a content item that is selected without consideration of relevance to the set of search results;
applying the machine learning model to user data of the target user to output a sensitivity score for the target user;
selecting one or more content items from the set of content items, wherein a degree to which the relevance scores of the set of content items is used in the selecting is based on the sensitivity score;
incorporating the selected content items into the set of search results; and
sending the set of search results with the selected content items for display to the target user, wherein the sending causes a device of the target user to display the set of search results and the selected content items.

2. The method of claim 1, wherein the machine learning model comprises:
a first model that predicts whether a user will engage with a set of search results if a content item that is selected with consideration of relevance to the search results is incorporated into the set of search results; and
a second model that predicts whether a user will engage with a set of search results if a content item that is selected without consideration of relevance to the search results is incorporated into the set of search results;
wherein the sensitivity score is a difference between an output of the first model and an output of the second model.

3. The method of claim 2, further comprising:
training the first model based on data describing user actions with a first set of search results when a first content item that is selected with consideration of relevance to the first set of search results is incorporated into the first set of search results; and
training the second model based on data describing user actions with a second set of search results when a second content item that is selected without consideration of relevance to the second set of search results is incorporated into the second set of search results.

4. The method of claim 1, wherein the machine learning model comprises a conditional treatment effect model, wherein a treatment is selecting a content item to be incorporated into the set of search results with consideration of relevance to the search results, and wherein the machine learning model outputs a prediction of an increased likelihood in engagement with the search results if the treatment is selected.

5. The method of claim 4, further comprising:
obtaining additional training data that comprises a label indicating whether the target user engaged with the search results sent to the target user and a set of features describing the target user; and
retraining the machine learning model using the additional training data.

6. The method of claim 1, wherein selecting one or more content items from the set of content items based on the sensitivity score and the relevance scores of the content items comprises:
determining a minimum relevance threshold based on the sensitivity score;
determining whether a relevance score of a content item is greater than the minimum relevance threshold; and
responsive to determining that the relevance score of the content item is greater than the minimum relevance threshold, selecting the content item from the set of content items.

7. The method of claim 6, wherein a greater sensitivity score corresponds to a higher minimum relevance threshold.

8. The method of claim 1, further comprising:
storing the sensitivity score in connection with an account of the target user; and
in response to a subsequent search query from the target user, using the stored sensitivity score to select one or more additional content items to include with a set of search results responsive to the subsequent query.

9. A computer program product comprising a non-transitory computer readable storage medium having instructions encoded thereon that, when executed by a processor, cause the processor to perform steps of:
receiving a query from a target user;
retrieving a set of search results responsive to the query;
retrieving a set of content items for inclusion within the set of search results, where each of the set of content items has a relevance score to the query;
accessing a machine learning model trained to predict a sensitivity score that predicts a loss in engagement by a user with a set of search results caused by incorporating into the set of search results a content item that is selected without consideration of relevance to the set of search results;
applying the machine learning model to user data of the target user to output a sensitivity score for the target user;
selecting one or more content items from the set of content items, wherein a degree to which the relevance scores of the set of content items is used in the selecting is based on the sensitivity score;
incorporating the selected content items into the set of search results; and
sending the set of search results with the selected content items for display to the target user, wherein the sending causes a device of the target user to display the set of search results and the selected content items.

10. The computer program product of claim 9, wherein the machine learning model comprises:
a first model that predicts whether a user will engage with a set of search results if a content item that is selected with consideration of relevance to the search results is incorporated into the set of search results; and
a second model that predicts whether a user will engage with a set of search results if a content item that is selected without consideration of relevance to the search results is incorporated into the set of search results;
wherein the sensitivity score is a difference between an output of the first model and an output of the second model.

11. The computer program product of claim 10, the non-transitory computer readable storage medium having additional instructions encoded thereon that, when executed by a processor, cause the processor to perform additional steps of:
training the first model based on data describing user actions with a first set of search results when a first content item that is selected with consideration of relevance to the first set of search results is incorporated into the set of search results, the first model is trained to predict a first likelihood of a conversion following presentation of the first set of search results for a target user; and
training the second model based on data describing user actions with a second set of search results when a second content item that is selected without consideration of relevance to the second set of search results is incorporated into the second set of search results, the second model is trained to predict a second likelihood of a conversion following presentation of the second set of search results for the target user.

12. The computer program product of claim 9, wherein the machine learning model comprises a conditional treatment effect model, wherein the treatment is selecting a content item to be incorporated into the set of search results with consideration of relevance to the search results, and wherein the machine learning model outputs a prediction of an increased likelihood in engagement with the search results if the treatment is selected.

13. The computer program product of claim 9, the non-transitory computer readable storage medium having additional instructions encoded thereon that, when executed by a processor, cause the processor to perform additional steps of:
obtaining additional training data that comprises a label indicating whether the target user engaged with the search results sent to the target user and a set of features describing the target user; and
retraining the machine learning model using the additional training data.

14. The computer program product of claim 13, wherein selecting one or more content items from the set of content items based on the sensitivity score and the relevance scores of the content items comprises:
determining a minimum relevance threshold based on the sensitivity score;
determining whether a relevance score of a content item is greater than the minimum relevance threshold; and
responsive to determining that the relevance score of the content item is greater than the minimum relevance threshold, selecting the content item from the set of content items.

15. The computer program product of claim 14, wherein a greater sensitivity score corresponds to a higher minimum relevance threshold.

16. The computer program product of claim 9, further comprising:
storing the sensitivity score in connection with an account of the target user; and
in response to a subsequent search query from the target user, using the stored sensitivity score to select one or more additional content items to include with a set of search results responsive to the subsequent query.

17. A computer system, comprising:
a processor; and
a non-transitory computer readable storage medium having instructions encoded thereon that, when executed by the processor, cause the processor to perform steps of:
receiving a query from a target user;
retrieving a set of search results responsive to the query;
retrieving a set of content items for inclusion within the set of search results, where each of the set of content items has a relevance score to the query;
accessing a machine learning model trained to predict a sensitivity score that predicts a loss in engagement by a user with a set of search results caused by incorporating into the set of search results a content item that is selected without consideration of relevance to the set of search results;
applying the machine learning model to user data of the target user to output a sensitivity score for the target user;
selecting one or more content items from the set of content items, wherein a degree to which the relevance scores of the set of content items is used in the selecting is based on the sensitivity score;
incorporating the selected content items into the set of search results; and
sending the set of search results with the selected content items for display to the target user, wherein the sending causes a device of the target user to display the set of search results and the selected content items.

18. The computer system of claim 17, wherein the machine learning model comprises:
a first model that predicts whether a user will engage with a set of search results if a content item that is selected with consideration of relevance to the search results is incorporated into the set of search results; and
a second model that predicts whether a user will engage with a set of search results if a content item that is selected without consideration of relevance to the search results is incorporated into the set of search results;
wherein the sensitivity score is a difference between an output of the first model and an output of the second model.

19. The computer system of claim 18, the non-transitory computer readable storage medium having additional instructions encoded thereon that, when executed by a processor, cause the processor to perform additional steps of:
training the first model based on data describing user actions with a first set of search results when a first content item that is selected with consideration of relevance to the first set of search results is incorporated into the set of search results; and
training the second model based on data describing user actions with a second set of search results when a second content item that is selected without consideration of relevance to the second set of search results is incorporated into the second set of search results.

20. The computer system of claim 17, wherein the machine learning model comprises a conditional treatment effect model, wherein the treatment is selecting a content item to be incorporated into the set of search results with consideration of relevance to the search results, and wherein the machine learning model outputs a prediction of an increased likelihood in engagement with the search results if the treatment is selected.
